(19) United States
(12) Patent Application Publication
(10) Pub. No.: US 2007/0174886 A1
(43) Pub. Date: Jul. 26, 2007

(54) Method for supporting services in an ip-based video network on the basis of subscriber-controlled status information

(76) Inventors: Axel Scheuer, Munchen (DE); Stefan Unger, Unterhaching (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/587,773

(22) PCT Filed: Jan. 11, 2005
(86) PCT No.: PCT/EP05/50091

§ 371 Date: Jul. 28, 2006

(30) Foreign Application Priority Data
Jan. 29, 2004 (EP) 04002000.0

(51) Int. Cl. H04N 7/173; H04L 12/28; H04L 12/56

(52) U.S. Cl. 725/110; 725/112; 725/113; 370/395.52

(57) ABSTRACT

In one aspect, a method to for supporting services of an IP-based video network is provided. A plurality of subscribers of the video network registers with a presence server, each subscriber registers via an IP-capable terminal. The plurality of subscribers includes a first subscriber that logs onto the presence server when the terminal of the first subscriber is activated resulting in presence information being stored in the presence server. The first subscriber requests presence information about at least a portion of the plurality of subscribers which is provided to the fist subscriber.

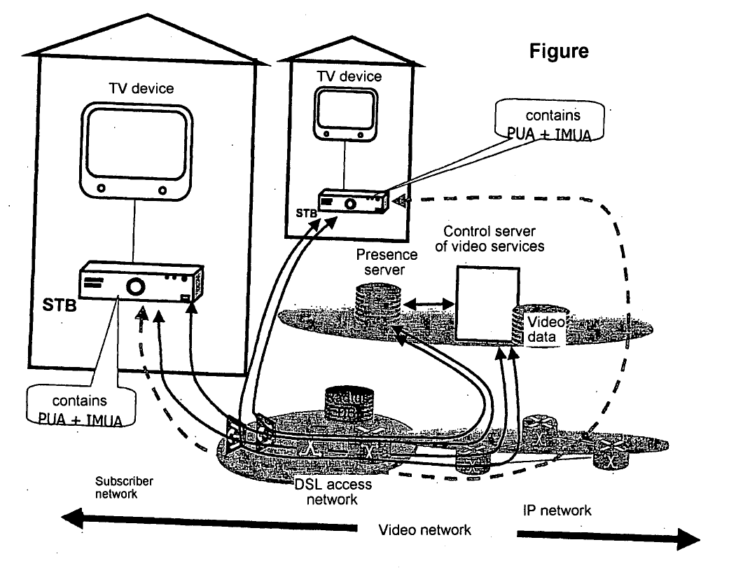

### CROSS REFERENCE TO RELATED APPLICATIONS

This application is the US National Stage of International Application No. PCT/EP2005/050091, filed Jan. 11, 2005 and claims the benefit thereof. The International Application claims the benefits of European application No. 04002000.0 EP filed Jan. 29, 2004, both of the applications are incorporated by reference herein in their entirety.

### FIELD OF INVENTION

The present invention relates to a method for supporting services in an IP-based video network on the basis of subscriber-controlled status information.

### BRIEF DESCRIPTION OF THE DRAWINGS

The sole FIGURE is an exemplary embodiment of video network in accordance with the present invention.

### DETAILED DESCRIPTION OF INVENTION

Typically, IP-based video networks offer entertainment services which transmit films and other video data to subscribers by means of video streaming. The terminal which receives said video data is a set-top box (STB) which is connected to a TV device. IP-based video networks with digital transmission of video data can have different topologies, e.g. can be based on DSL technology or on cable networks.

Operators of such networks looking for new business opportunities can find it interesting to offer other services in addition. The inventive method describes how presence-based services can be offered to the subscribers of such video networks, taking specific network data into account. Examples of presence-based services are Instant Messaging (i.e. the exchanging of text messages in real time) between the subscribers of the video network via the TV device or the automatic initiation of a video conference where the required subscribers are available or the shared playing of online games with subscribers registered on a Buddy List.

To date, current video network solutions do not offer any integrated services.

Simple solutions are conceivable whereby additional PCs are connected to the network in parallel with the TV device plus STB terminals, which then permit communication services between the PCs.

Furthermore, there are solutions for sending short text messages to larger subscriber groups which can be overlaid over the video image currently visible on the TV device, e.g. severe weather warnings. However, these are not individual messages to specified subscribers and are distributed only from the central control server to the subscriber group. Support for communication services such as e.g. Instant Messaging (IM)/Chat between subscribers to a video network, taking presence information into account, is not yet known.

The inventive method enables the support of presence-based communication services for subscribers to an IP-based video network.

In order to implement the method, the presence server in the video network is essential. This server stores the presence information for the subscribers to the video network. The presence information of the video subscribers comprises information such as e.g.
the video subscriber is online, i.e. his/her STB is active and is registered and authenticated in the central control server of the video network
addresses under which the subscriber can be reached (e.g. IP address or usemame@domain)
which service the video subscriber is using at the moment (e.g. watching a film booked via Video on Demand or playing a game for multiple players online on a server in the video network)
personal opinion of the video subscriber (“do not want to be disturbed”, “look forward to receiving a message”, “looking for other players”)
Furthermore, the server can also maintain lists containing the addresses and presence information of friends/earlier communication partners (“buddy lists”). For security reasons, the presence server contains profiles for all subscribers or presence users. This ensures that e.g. only registered users can request or transmit presence data or that users can request data (“watchers”) only if the user whose presence data is being requested (“presentity”) has permitted this.

In order to improve the facilities of the inventive method, the presence server advantageously has an interface to the control server of the video network, which control server controls all video services. (The customary designation for the application on the control server for video services is “middleware”. Typically, the control server knows the status of all services which are running (→“sessions”) for online video subscribers, as this control server is responsible, among other things, for charging and statistics in respect of the services. The presence server can request detailed information on the services used by the video subscribers, e.g. which subscriber is currently using which service in what detailed breakdown or form, via the interface between presence server and control server. With this information, the presence server can for example draw up for itself a list of all the subscribers who are watching a certain film via VoD or a certain football match on a DVB (digital video broadcast) channel.

Furthermore, the following software applications are integrated in the SW client on the STB:
Presence User Agent (PUA):
   This software application logs on to the presence server in the network as soon as the video subscriber is online, i.e. his/her STB is active. Equally, the subscriber can log off again (“offline” status=“not present”) or change his/her status during a video session. Part of the log-on data in the presence server is the additional information mentioned above such as opinion and information about the service being used. The application also allows the requesting of the presence status of other video subscribers in the network by the presence server. Such a request can be made on the basis of certain criteria, e.g. which subscriber is currently watching a certain film.
   The application permits the display of the presence status of the subscriber and of other subscribers (taken from his/her “buddy list” or from other lists offered by the presence server) in dedicated windows on the TV device.
At least one service application, e.g. Instant Message/Chat User Agent (IMUA): The IMUA software application permits the immediate exchange of text messages with other Instant Message/Chat User Agents. Depending on the application's options, one-to-one communication or even one-to-n communication is conceivable. The application is linked to the PUA application, i.e. using the presence information of certain subscribers, an IM/Chat session can be initiated with subscribers who are online and optionally fulfill further required criteria.

Today's STBs have the basic technical facility to integrate such software applications into the client software on the STB. In this case, these UA applications run directly on the STB and communicate with the servers in the network or other STBs. The signaling protocols for this can be proprietary or else standard protocols. Standard protocols for presence are standardized e.g. in the IETF under SIMPLE or 3GPP PAM. The standard protocols would optionally have to be extended for an implementation according to the invention if video-network-specific information (e.g. data about films or DVB channels) cannot be transmitted in standard parameters.

Standard protocols (e.g. in the IETF) or open source implementations (e.g. Jabber) could also be used for the exchange of instant messages and for the UA.

As a variant, the inventive method is also conceivable with STBs which have only an HTML-capable browser (“thin clients”) and which support communication with the central video control server exclusively via HTTP. In this case, said UA applications have to be integrated on the control server. Activation of the corresponding procedures for the updating and requesting of presence data on the presence server by the video subscriber then has to be mapped on HTML pages which then forward corresponding control information to the PUA application. The PUA application then communicates with the presence server as described above. Likewise, the exchange of instant messages/chat can also be mapped on HTML pages.

The STB is also designed to allow text fields in which received or even written messages are shown to be displayed on the TV device either as a single full-screen image or as a partial image which is overlaid over another image (e.g. video film). Essentially, “alphablending” technology, which is supported by state-of-the-art STB chips, permits the overlaying of TV images. Consequently, an STB application like the PUA, for example, can generate information in the format of a TV image and mix it with a TV signal and display the mixed image on a TV device. A display as a partial image allows the subscriber to run an IM/Chat session in parallel with a video program that is running. Similarly, the online-status information regarding presence is also designed to be displayable as a full-screen image or as an overlaid image.

For inputting text, the STB typically has an external keyboard which can be connected either cordlessly (via infra-red) or directly by means of a cable. A “virtual” keyboard, i.e. a keyboard shown on the TV device on which the subscriber selects letters by means of remote control, is also conceivable. Simplified inputting algorithms like the “T9” algorithm for mobile telephone terminals are also conceivable.

The inventive method allows new communication services like e.g. IM/Chat, presence-controlled video conferences or online games with subscribers on a buddy list to be offered between the subscribers of an IP-based video network. The central presence server not only permits the recording of information as to “which subscriber is currently online (STB active)” but can also record video-network-specific data such as e.g. which service a logged-on subscriber is using. This makes it possible, for example, to initiate IM/Chat sessions with subscribers who are watching the same film or who are simultaneously using other services of the video network. Where text input and output fields are overlaid over a video image, e.g. in the lower area, video subscribers can communicate at the same time that a video transmission is running.

OPTIONS:

If the presence server in the video network also allows the registration of IP subscribers in other networks, e.g. mobile telephone subscribers with PUA or IP subscribers who are surfing the Internet and have a suitable PUA, then presence-based communication is also possible between these subscribers and the video network subscribers. Prerequisites for this are, of course, compatible PUA and IMUA applications on the terminals and in the presence server. Equally, the video network must enable the corresponding IP-based signaling via a suitable gateway into the external IP network. As a variant, it would also be feasible for direct communication to take place between the presence server of the video network and other presence servers.
The presence server described and the PUA in the STB are generic and can be combined with other communication services, e.g. for presence-based video telephony or video conferencing—provided the video network offers the technical facilities for doing so.

An exemplary embodiment of the inventive method is shown in the figure.

The simplified example shows an IP-based video network which is implemented on the basis of an ADSL network. The STBs of video subscribers communicate with the central control server for video services. For example, by means of EPG (electronic program guide), films can be selected for VoD. The control server transmits the addresses to the servers with the digital video data. The control server monitors the running of these video sessions and controls the charging. According to the invention, the SW on the STB contains the applications for presence (PUA) and instant messaging (IMUA). When the STB is activated, the PUA updates the presence data for the video subscriber in the central presence server. The PUA in the STB fetches the presence data from other subscribers on demand, e.g. for all the subscribers who are entered in the Buddy List. The PUA application displays this presence data on demand (e.g. by pressing a knob on the STB remote control) on the connected TV device.

The video subscriber 1 (video Tln 1) recognizes from the status information for his/her Buddy List which is displayed to him/her that the video subscriber 2 (Video Tln 2) is online. By selecting this subscriber with his/her STB remote control, the subscriber 1 can initiate an IM session with this subscriber 2, i.e. IM data is exchanged in accordance with the implemented protocol between subscriber 1 and subscriber 2 via an IP-based connection (shown by a dashed, orange line). The text messages are displayed on the TV device. Text is input via an IR-controlled keyboard (keyboard not shown).

### Abbreviations

IM: Instant Message
IMUA: Instant Message/Chat User Agent
IP: Internet Protocol
PUA: Presence User Agent
STB: Set Top Box
SW: Software
UA: User Agent
VoD: Video on Demand

1.-15. (canceled)

16. A method for supporting services of an IP-based video network, comprising:
registering a plurality of subscribers of the video network with a presence server, each subscriber registering via an IP-capable terminal;
logging onto the presence server when the terminal of a first subscriber is activated, the plurality of subscribers including the first subscriber;
storing information about a presence status of the first subscriber in the presence server as a result of the logging onto the presence server;
requesting presence information about at least a portion of the plurality of subscribers by the first subscriber via the terminal; and
providing presence information about the portion of subscribers to the first subscriber in response to the presence request.

17. The method according to claim 16, further comprising:
requesting further video-network-specific information about at least a portion of the plurality of subscribers; and
providing the further information to the first subscriber in response to the further request.

18. The method according to claim 17, wherein the further information includes which of the portion of plurality of subscribers is viewing a specific film.

19. The method according to claim 17, wherein the further information includes for each of the portion of plurality of subscribers a service used by the respective subscriber.

20. The method according to claim 17, wherein the further information includes for each of the portion of plurality of subscribers a file being seen by the respective subscriber.

21. The method according to claim 17, wherein a service is made available to the first subscriber based on information received about the portion of plurality of subscribers.

22. The method according to claim 21, wherein a subscriber of another IP-based network is enabled to log on to the presence server.

23. The method according to claim 16, wherein a subscriber of another IP-based network is enabled to log on to the presence server.

24. A presence server within a communication system, comprising:
a presence data of a plurality of subscribers of an IP-based video network; and
a request handler that receives by a first subscriber a request for the presence data of at least a portion of the plurality of subscribers, the plurality of subscribers includes the first subscriber,
wherein the presence data of the at least the portion of the plurality of subscribers is sent to the first subscriber in response to the request.

25. The presence server as claimed in claim 24,
further comprising an interface to a control server that controls the video services of the video network,
wherein the server can request information of a service used by a portion of the plurality of subscribers.

26. An IP-capable terminal of a video network that is operatively connected to a TV device of a first subscriber, the terminal comprising:
a subscriber request for a presence information of at least one other subscriber of the video network initiated by the first subscriber, the request sent to a central device of the video network; and
a subscriber presence information response received in response to the request,
wherein based on the response presence information is displayed on the TV device.

27. The terminal as claimed in claim 26, wherein the first subscriber initiates a communication service via the terminal to the subscriber that presence information has been received.

28. The terminal as claimed in claim 27, wherein the communication service is an instant messaging service.

29. The terminal as claimed in claim 26, wherein the central device is a presence server.

30. The terminal as claimed in claim 26, wherein the central device is a control server that controls the video network.

31. The terminal as claimed in claim 26, wherein the subscriber request is in accordance to an IP-based protocol.

32. The terminal as claimed in claim 31, wherein IP based protocol is a SIP protocol or wherein the IP based protocol is HTTP protocol.

33. The terminal as claimed in claim 26, further comprising an application that fetches from a presence server a presence data for at least one other subscriber and displays this on the TV device of the first subscriber, the fetch in response to a prompt by the first subscriber of the video network via an IP-based protocol.

34. The terminal as claimed in claim 26, wherein the terminal is a set-top box (STB).
